(19) United States
(12) Patent Application Publication
(10) Pub. No.: US 2026/0295753 A1
(43) Pub. Date: Oct. 1, 2026

(54) DUST COLLECTING ATTACHMENT AND HAMMERING TOOL

(71) Applicant: MAKITA CORPORATION, Anjo-shi (JP)

(72) Inventor: Wataru SOGABE, Anjo-shi (JP)

(73) Assignee: MAKITA CORPORATION, Anjo-shi (JP)

(21) Appl. No.: 19/575,368

(22) Filed: Mar. 23, 2026

(30) Foreign Application Priority Data
Mar. 25, 2025 (JP) 2025-050497

(51) Int. Cl. B23Q 11/00; B25D 17/20

(52) U.S. Cl. CPC B23Q 11/0071; B23Q 11/0046; B25D 17/20; B25D 2217/0057

(57) ABSTRACT

A dust collecting attachment includes a tubular bit guiding portion, a tubular dust collection portion, and a connecting portion. The tubular bit guiding portion is attachable to and detachable from a bit of a hammering tool. The tubular dust collection portion has a rear end to which a dust collection hose is connectable assuming a distal end side of the bit as a front and a front end opened to form a suction port. The connecting portion connects the bit guiding portion to the dust collection portion. The bit guiding portion and the dust collection portion are integrated via the connecting portion in a state of being separated from one another.

### CROSS REFERENCE TO RELATED APPLICATION

This application claims the benefit of Japanese Patent Application Number 2025-050497 filed on Mar. 25, 2025, the entirety of which is incorporated by reference.

### FIELD OF THE INVENTION

The disclosure relates to a dust collecting attachment attached to a bit of a hammering tool, such as a hammer drill, for collecting dust, and a hammering tool on which the dust collecting attachment is mounted.

### BACKGROUND OF THE INVENTION

In a hammering tool, when a bit mounted on a distal end is hammered to perform an operation of chipping or crushing a workpiece, a dust collecting attachment is mounted on a distal end portion of the bit in some cases in order not to scatter the dust generated from the workpiece.

A known dust collecting attachment of the type is, for example, disclosed in DE102014221179A1. The dust collecting attachment in DE102014221179A1 includes a tubular suction unit mounted on a distal end portion of a bit, and a dust collecting tubular portion that is integrally formed on a side surface of the suction unit and opens into the suction unit. When a hose connected to an external dust collector is connected to a rear end of the dust collecting tubular portion, and a dust collector is driven, a suctioning force is generated in the suction unit, and thus, the dust generated from the distal end of the bit can be suctioned.

In the above-described conventional dust collecting attachment, the suction unit is in the tubular shape and largely covers the distal end of the bit. Therefore, the suction unit obstructs a line of sight of an operator, and it is difficult for the operator to see the distal end of the bit. In addition, a slit is formed in the suction unit for facilitating the insertion of the bit, which has a possibility of causing a decreased suctioning force.

Therefore, it is an object of the disclosure to provide a dust collecting attachment and a hammering tool that do not impair visibility of an operator even when the dust collecting attachment is mounted on a bit, and allow for securing a suctioning force.

### SUMMARY OF THE INVENTION

In order to achieve the above-described object, a first configuration of the present disclosure is a dust collecting attachment. The dust collecting attachment includes a tubular bit guiding portion, a tubular dust collection portion, and a connecting portion. The tubular bit guiding portion is attachable to and detachable from a bit of a hammering tool. The tubular dust collection portion has a rear end to which a dust collection hose is connectable assuming a distal end side of the bit as a front and a front end opened to form a suction port. The connecting portion connects the bit guiding portion to the dust collection portion. The bit guiding portion and the dust collection portion are integrated via the connecting portion in a state of being separated from one another.

In order to achieve the above-described object, a second configuration of the present disclosure is a hammering tool. The hammering tool is formed by mounting the dust collecting attachment according to the first configuration on a bit attached to a front end portion.

The disclosure reduces the possibility of a dust collection portion obstructing a line of sight of an operator who visually perceives a bit since the dust collection portion is separated from a bit guiding portion. In addition, since the dust collection portion is not provided with a cutout or a slit for mounting onto the bit, a suctioning force at a suction port is not decreased. Accordingly, even though a dust collecting attachment is mounted on the bit, the visibility of the operator is not impaired, and the suctioning force is securable.

### BRIEF DESCRIPTION OF THE DRAWINGS

FIG. 1 is a perspective view from a front of a dust collecting attachment.

FIG. 2 is a perspective view of a rear of the dust collecting attachment.

FIG. 3 is a front view of the dust collecting attachment.

FIG. 4 is a cross-sectional view taken along the line A-A in FIG. 3.

FIG. 5 is a perspective view from a rear of a hammer drill with the dust collecting attachment.

FIG. 6 is a partial front view of the hammer drill with the dust collecting attachment.

FIG. 7 is a partial plan view of the hammer drill with the dust collecting attachment.

### DETAILED DESCRIPTION OF THE INVENTION

In one embodiment of the present disclosure, the suction port may be positioned i a front with respect to the bit guiding portion.

The configuration allows for suctioning dust at a position close to an area being processed by a bit, which improves suction efficiency.

In one embodiment of the present disclosure, the dust collection portion may be arranged in one of half sides divided using a predetermined virtual plane including an axis line of the bit guiding portion as a border in front view.

The configuration opens the other half side in the bit guiding portion, which allows the operator to more easily visually perceive the area being machined by the bit.

In one embodiment of the present disclosure, the bit guiding portion and the dust collection portion may be arranged such that an angle formed by axis lines of the bit guiding portion and the dust collection portion is an acute angle that narrows as approaching the front.

The configuration allows for arranging the suction port at a position close to the processing site even though the dust collection portion is separated from the bit guiding portion.

In one embodiment of the present disclosure, the bit guiding portion may be provided with a cutout extending in an axis line direction of itself and circumferentially separating a part of the bit guiding portion.

The configuration allows for attaching the bit guiding portion from a side of the bit.

In one embodiment of the present disclosure, the cutout may be provided on an opposite side of the suction port across the axis line of the bit guiding portion in front view.

With the configuration, the dust collection portion is not obstructive when the bit guiding portion is attached to the bit.

In one embodiment of the present disclosure, the cutout may be formed over an angle of 15° or more in the circumferential direction of the bit guiding portion.

The configuration allows for securing integration with the bit in a bit guiding portion attached state, which makes the bit guiding portion less likely to be removed from the bit.

In one embodiment of the present disclosure, the dust collecting attachment may be an integrally molded product made of a rubber having a hardness of 70 to 100.

The configuration allows for obtaining the dust collecting attachment excellent in durability and attachability/detachability.

In one embodiment of the present disclosure, the rubber may have a hardness from 85 to 95.

The configuration allows for obtaining the dust collecting attachment with a good balance in durability and attachability/detachability.

The following describes an embodiment of the disclosure based on the drawings.

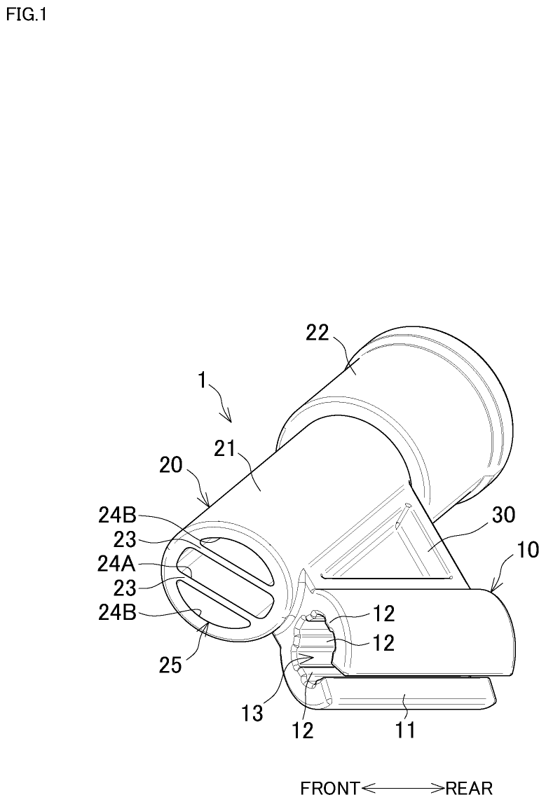

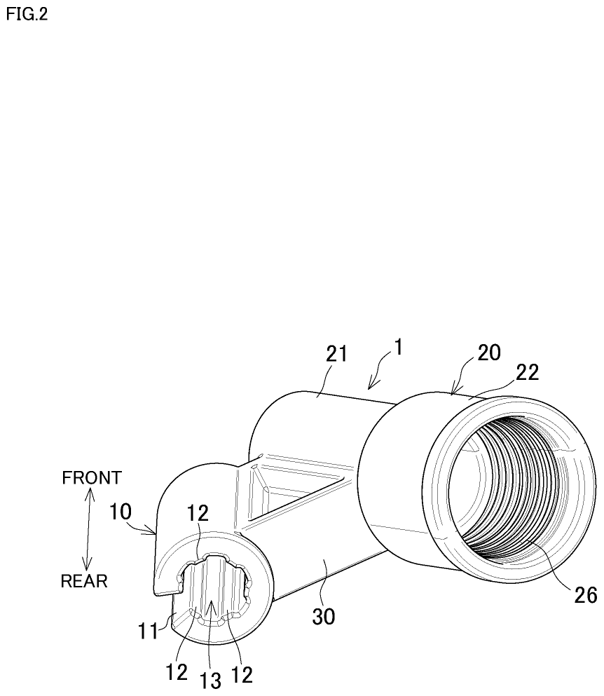

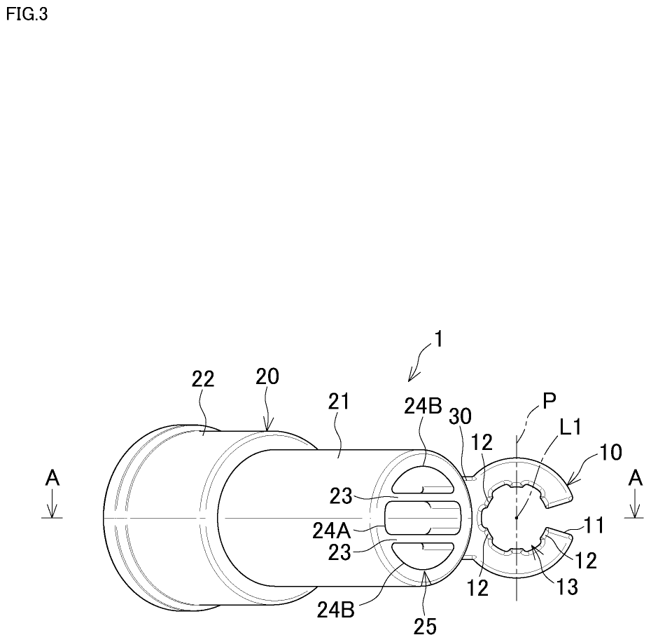

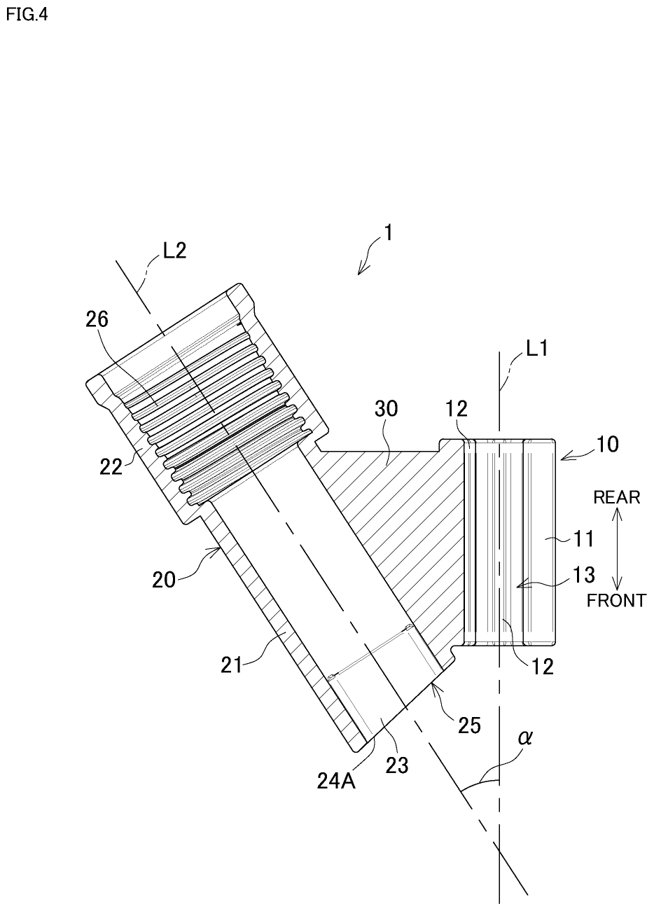

FIG. 1 is a perspective view from a front illustrating an example of a dust collecting attachment 1, hereinafter simply referred to as an “attachment,” FIG. 2 is a perspective view from a rear, FIG. 3 is a front view, and FIG. 4 is a cross-sectional view taken along the line A-A in FIG. 3.

The attachment 1 is an integrally molded product made of a rubber, and has a hardness, namely Shore A hardness scale, of 85 to 95. Having the hardness of 85 to 95 causes the attachment 1 to have a good balance in durability and attachability/detachability. The hardness of the rubber, however, is not limited to 85 to 95. It is only necessary to set the hardness within the range of 70 to 100 by taking the degree of importance of the durability and the attachability/detachability into account.

The attachment 1 includes a bit guiding portion 10, a dust collection portion 20, and a connecting portion 30.

The bit guiding portion 10 is a tubular body that partially has a cutout 11 formed over the whole length in a direction of an axis line L1. The cutout 11 is formed over the range of 30° in a circumferential direction of the bit guiding portion 10. The cutout 11 circumferentially separates a part of the bit guiding portion 10. The angle of the cutout 11, however, is not limited to 30°, and may be set to 15° or more as long as it is attachable to a bit 50, described later, from a side. Thus, making the cutout 11 as small as 15° or more allows for securing the integrity with the bit 50 in an attached state, which causes the bit guiding portion 10 to be less likely to be detached from the bit 50.

The bit guiding portion 10 has an inner circumferential surface on which a plurality, namely six here, of ridges 12 extending over the whole length in the axis line L1 direction are formed at regular intervals in the circumferential direction. The ridges 12 form a grip portion 13 having unevenness continuing in the circumferential direction on the inner circumferential surface of the bit guiding portion 10.

The dust collection portion 20 is a tubular body that has a front tubular portion 21 and a rear tubular portion 22 formed coaxially on an axis line L2. The front tubular portion 21 has a diameter larger than that of the bit guiding portion 10, and has a length in a direction of the axis line L2 longer than that of the bit guiding portion 10. The front tubular portion 21 has a front portion inner surface on which a pair of ribs 23 are formed in a parallel manner. The ribs 23 divide a front end of the front tubular portion 21 into three openings 24A, 24B, 24B. The opening 24A is formed between the ribs 23, and has the largest opening area. The openings 24B are formed between the ribs 23 and the inner circumferential surface of the front tubular portion 21 radially outside of the ribs 23, and have the same opening areas as one another. The three openings 24A, 24B form a suction port 25 that opens on an intersecting surface with the axis line L2 in the front end of the front tubular portion 21.

The rear tubular portion 22 is formed to have a diameter larger than that of the front tubular portion 21 and be shorter than the front tubular portion 21 in the axis line L2 direction. The rear tubular portion 22 has an inner surface on which a female thread portion 26 is formed.

The connecting portion 30 is in a triangular plate shape having a thickness smaller than an outer diameter of the bit guiding portion 10. The connecting portion 30 has one side of two sides of the triangle connected to an outer circumferential surface of the bit guiding portion 10, and the other side connected to an outer circumferential surface of the front tubular portion 21 of the dust collection portion 20. In the connected state, the axis line L1 of the bit guiding portion 10 and the axis line L2 of the dust collection portion 20 intersect at an angle α illustrated in FIG. 4, in a front of the attachment 1. The angle α is an acute angle, namely 45° here. The bit guiding portion 10 and the dust collection portion 20, however, are separated from one another with the connecting portion 30 interposed therebetween, and are independent of each other and integrated with the connecting portion 30.

The suction port 25 of the dust collection portion 20 is positioned in a front side with respect to a front end of the bit guiding portion 10 in the axis line L1 direction. The cutout 11 of the bit guiding portion 10 is positioned on an opposite side of the suction port 25 with the axis line L1 interposed therebetween as illustrated in FIG. 3 in front view. The dust collection portion 20 is arranged in one side, namely the left half side in FIG. 3, of the half sides which are separated using a predetermined virtual plane P including the axis line L1 as a border in front view. The ribs 23 of the suction port 25 are perpendicular to the virtual plane P in front view.

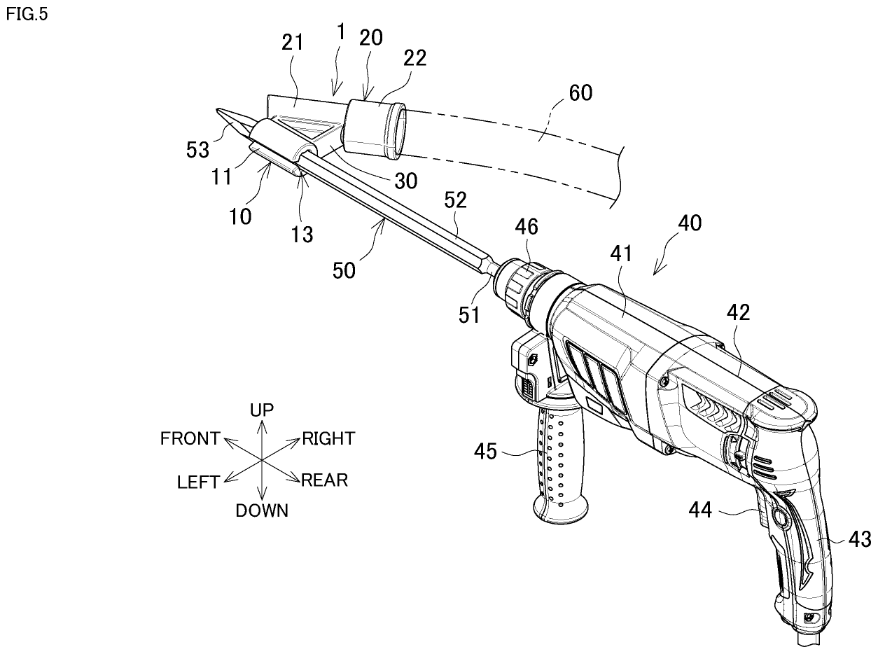

A hammer drill 40 has a front housing 41 and a rear housing 42 that extend in a front-rear direction as illustrated in FIG. 5. The rear housing 42 accommodates a motor (not illustrated). The rear housing 42 has a rear portion forming a handle 43 downward. The handle 43 is provided with a trigger 44.

The front housing 41 accommodates a rotating/hammering portion (not illustrated) that operates by rotation of a rotation shaft of the motor. The front housing 41 has a front portion on which a side handle 45 is attached. An operation portion 46 for attaching and detaching the bit 50 inserted into a tool holder of the rotating/hammering portion from the front is disposed at a front end of the front housing 41 in a front side of the side handle 45. The front housing 41 has a lower surface on which a switching lever (not illustrated) is disposed for switching each of the modes, a rotating mode, a hammering mode, and a rotating/hammering mode in the rotating/hammering portion.

The attachment 1 is attached to a distal end of the bit 50 mounted on the hammer drill 40. Here, a bull point is exemplarily illustrated as the bit 50, and is constituted of a shank portion 51, a shaft portion 52, and a pointed end portion 53. The shank portion 51 is inserted in the tool holder inside the operation portion 46. The shaft portion 52 has a hexagonal cross-section and extends forward from the shank portion 51. The pointed end portion 53 is formed in a front side of the shaft portion 52 and is tapered off.

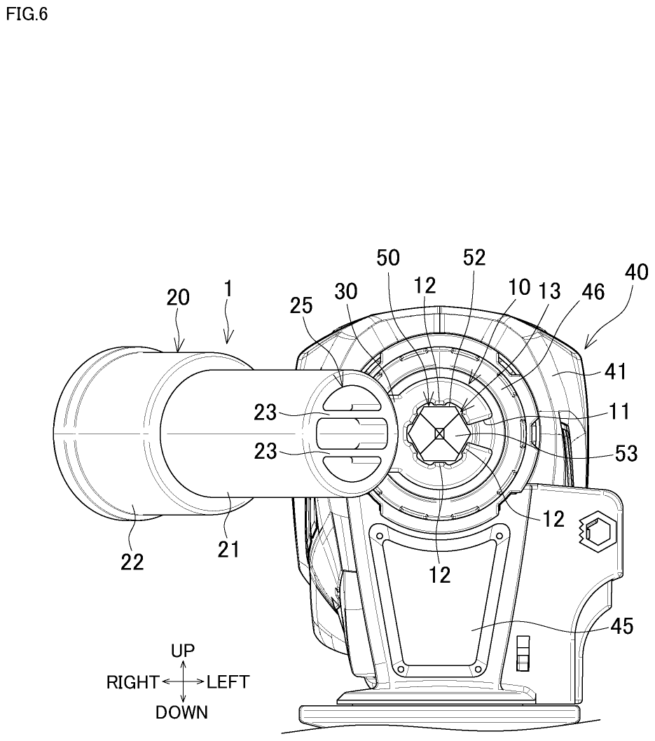

The cutout 11 of the bit guiding portion 10 of the attachment 1 is pressed against a side surface of the shaft portion 52 of the bit 50 to expand the cutout 11, and thus the bit guiding portion 10 is elastically deformed. The shaft portion 52 then move into the bit guiding portion 10 beyond the cutout 11. Accordingly, as illustrated in FIG. 6, the shaft portion 52 is gripped in the grip portion 13 of the bit guiding portion 10 in a coaxial manner. At this time, each of the ridges 12 of the grip portion 13 engage with each of corner portions of the hexagon of the shaft portion 52 in the rotation direction, and thus, the bit guiding portion 10 is in the state of being stopped from rotating with respect to the shaft portion 52.

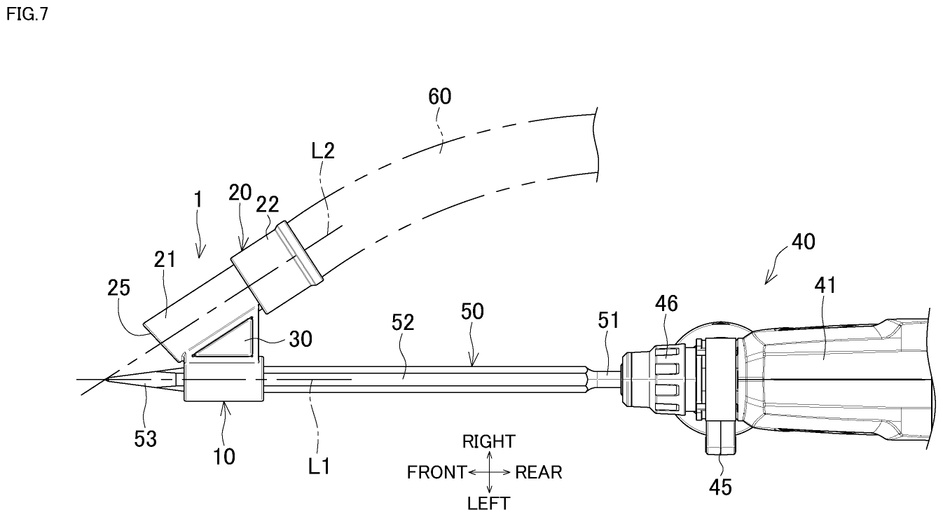

In the state where the attachment 1 is attached to the bit 50, the dust collection portion 20 is in an inclined posture in which the suction port 25 positioned in the front with respect to the front end of the bit guiding portion 10 points toward the pointed end portion 53 as illustrated in FIG. 7.

Thus, the attachment 1 is attachable from the side of the bit 50, which eliminates the need for considering the order of attaching the attachment 1 to the hammer drill 40. Specifically, the attachment 1 may be attached to the bit 50 after attaching the bit 50 first to the hammer drill 40 as described above, or the bit 50 may be mounted on the hammer drill 40 after attaching the attachment 1 first to the bit 50.

When, for example, a chipping work is performed on a workpiece by the hammer drill 40 with the attachment 1 configured as described above, a flexible hose 60 is connected to the rear tubular portion 22 of the dust collection portion 20 as illustrated with the two-dot chain lines in FIG. 5 and FIG. 7. The connection is performed by threadably engaging a screw portion provided in one end portion of the flexible hose 60 with the female thread portion 26 of the rear tubular portion 22. The other end part of the flexible hose 60 is connected to an external dust collector (not illustrated). The flexible hose 60 is one example of the dust collection hose of the disclosure.

When the dust collector is operated, the inside of the dust collection portion 20 is caused to be in a negative pressure via the flexible hose 60, and the suctioning force is generated at the suction port 25. Here, an operator selects the hammering mode, and when the operator is right-handed, grips the side handle 45 with his/her left hand and grips the handle 43 with his/her right hand to support the hammer drill 40, and presses the pointed end portion 53 of the bit 50 against the workpiece to position it at a chipping position. When the hammer drill 40 is operated by pushing the trigger 44 in the state, the bit 50 is hammered by the rotating/hammering portion to perform the chipping of the workpiece. It should be noted that, when the dust collector operates in conjunction with the hammer drill 40, the operation of the dust collector is not required, and the operation of only the hammer drill 40 is enough.

The dust generated from the workpiece by the chipping work is suctioned from the suction port 25 together with the air and suctioned into the dust collector via the flexible hose 60 from the dust collection portion 20. Accordingly, the dust can be effectively discharged concurrently with the chipping work. At this time, the dust collection portion 20 is positioned in the right side of the bit 50, and therefore, the operator can visually perceive the position of chipping by the pointed end portion 53 without being obstructed by the dust collection portion 20 or the flexible hose 60. When the operator is left-handed, the direction of attaching the attachment 1 to the bit 50 is inverted to position the dust collection portion 20 on the left side of the bit 50. Depending on the working position and the direction of the work, the attachment 1 is simply attached to position the dust collection portion 20 on the upper side or the lower side of the bit 50.

Thus, in the attachment 1 and the hammer drill 40 of the above-described example, the attachment 1 includes the tubular bit guiding portion 10, the tubular dust collection portion 20, and the connecting portion 30. The tubular bit guiding portion 10 is attachable/detachable to/from the bit 50 of the hammer drill 40. The tubular dust collection portion 20 has the rear end, by assuming the distal end side of the bit 50 as the front, to which the flexible hose 60 connectable, and the front end opened to form the suction port 25. The connecting portion 30 connects the bit guiding portion 10 to the dust collection portion 20.

The bit guiding portion 10 and the dust collection portion 20 are integrated in the state of being separated from one another via the connecting portion 30.

With the configuration, since the dust collection portion 20 is separated from the bit guiding portion 10, the possibility of the dust collection portion 20 obstructing the line of sight of the operator who visually perceives the bit 50 is reduced. In addition, the dust collection portion 20 does not have the cutout 11 for mounting onto the bit 50, and therefore, the suctioning force at the suction port 25 is not reduced. Accordingly, even though the attachment 1 is mounted on the bit 50, the visibility of the operator is not impaired, and the suctioning force can also be secured.

The suction port 25 is positioned in the front with respect to the bit guiding portion 10.

Accordingly, the dust can be suctioned at a position close to the position chipped by the bit 50, which improves the suction efficiency.

The dust collection portion 20 is arranged in the one of the half sides separated using the predetermined virtual plane P including the axis line L1 of the bit guiding portion 10 as a border in front view.

Accordingly, the other half side in the bit guiding portion 10 is opened, which allows the operator to more easily visually perceive the position chipped by the bit 50.

The bit guiding portion 10 and the dust collection portion 20 are arranged such that the angle α formed by the axis lines L1, L2 of the bit guiding portion 10 and the dust collection portion 20 form an acute angle that narrows as approaching the front.

Accordingly, even though the dust collection portion 20 is separated from the bit guiding portion 10, the suction port 25 can be arranged at a position close to the chipping position.

The bit guiding portion 10 is provided with the cutout 11 extending in the axis line L1 direction of itself and circumferentially separating a part of the bit guiding portion 10.

Accordingly, the bit guiding portion 10 is attachable from the side of the shaft portion 52.

The cutout 11 is provided on the opposite side of the suction port 25 with the axis line L1 of the bit guiding portion 10 interposed therebetween in front view.

Accordingly, the dust collection portion 20 does not become an obstruction when the bit guiding portion 10 is attached to the shaft portion 52.

The cutout 11 is formed over the angle of 15° or more in the circumferential direction of the bit guiding portion 10.

Accordingly, the integrity with the bit 50 is securable in the attached state of the bi guiding portion 10, and thus, the bit guiding portion 10 is less likely to be detached from the bit 50.

The attachment 1 is an integrally molded product by a rubber with a hardness of 70 to 100.

Accordingly, the attachment 1 excellent in durability and attachability/detachability is obtainable.

The hardness of the rubber is 85 to 95.

Accordingly, the attachment 1 with a good balance in durability and attachability/detachability is obtainable.

The following describes modifications of the disclosure.

The angle formed by the axis lines of the bit guiding portion and the dust collection portion is not limited to 45°, and is changeable as necessary. The connecting portion is formed to correspond to the angle. The connecting portion is not necessarily in one plate shape, but may be formed with a plurality of plate bodies or rod bodies to connect the bit guiding portion to the dust collection portion.

The position of the cutout is also not limited to the configuration, as in the above example, in which the cutout is located on the side surface opposite the suction port, with the axis of the bit guide portion interposed between them. For example, the cutout may also be provided on the upper surface or the lower surface of the bit guiding portion in the above-described example. It is also possible to have a configuration in which the cutout is eliminated and the bit is inserted into the bit guiding portion.

The number of the ridges of the bit guiding portions is not limited to the above-described example, and may be increased or decreased as necessary. The shape of the ridge is also changeable. The ridge may be partly provided in the front portion and/or the rear portion, not the whole length of the bit guiding portion in an axis line direction. As long as the shaft portion can be gripped, the ridge is not required.

The bit guiding portion may be formed of a plurality of tubular shapes separated i an axis line direction, not the one tubular shape.

The dust collection portion may have two tier diameters with the rear tubular portion having a smaller diameter or may have three tiers or more multiple tier diameters, instead of having the two tier diameters with the front tubular portion having a smaller diameter as the above-described example. The dust collection portion may have an equal diameter over the whole length or may be in a taper shape over the whole length.

The suction port of the dust collection portion may be formed by increasing or decreasing the number of the ribs or omitting the ribs. The portion of the suction port may be in a tapered shape. The intersecting surface with the axis line where the suction port is formed may have a larger angle than that in the above-described example and be inclined to further point toward the axis line of the bit guiding portion, or conversely, the suction port may be formed on the perpendicular surface with the axis line.

The dust collection portion may have a connecting structure other than the threadable engagement as long as the dust collection hose is connectable. For example, the connecting structure may employ bayonet coupling or may employ simple insertion coupling. The dust collection portion may have a structure in which it is inserted into the dust collection hose.

The attachment may be integrally formed using another synthetic resin material, instead of rubber. The attachment is, however, not limited to an integrally molded product, and may be formed in respective separate bodies connected with the connecting portions. For example, the bit guiding portion may be made of a rubber and the dust collection portion may be made of a synthetic resin, and these two may be connected via the connecting portion made of a rubber or a synthetic resin, or a metal. That is, the material of each of the configuration units is changeable as necessary.

The hammering tool may, for example, be an electric hammer, not limited to the hammer drill of the above-described example. As long as the attachment is mountable on the mounted bit, the disclosure is also applicable to another hammering tool. The bit is also not limited to the bull point, and may be another type, such as a chisel.

It is explicitly stated that all features disclosed in the description and/or the claims are intended to be disclosed separately and independently from each other for the purpose of original disclosure as well as for the purpose of restricting the claimed invention independent of the composition of the features in the embodiments and/or the claims. It is explicitly stated that all value ranges or indications of groups of entities disclose every possible intermediate value or intermediate entity for the purpose of original disclosure as well as for the purpose of restricting the claimed invention, in particular as limits of value ranges.

1. A dust collecting attachment comprising:
a tubular bit guiding portion attachable to and detachable from a bit of a hammering tool;
a tubular dust collection portion that has a rear end to which a dust collection hose is connectable assuming a distal end side of the bit as a front and a front end opened to form a suction port; and
a connecting portion that connects the bit guiding portion to the dust collection portion, wherein
the bit guiding portion and the dust collection portion are integrated via the connecting portion in a state of being separated from one another.

2. The dust collecting attachment according to claim 1, wherein
the suction port is positioned in a front with respect to the bit guiding portion.

3. The dust collecting attachment according to claim 1, wherein
the dust collection portion is arranged in one of half sides divided using a predetermined virtual plane including an axis line of the bit guiding portion as a border in front view.

4. The dust collecting attachment according to claim 1, wherein
the bit guiding portion and the dust collection portion are arranged such that an angle formed by axis lines of the bit guiding portion and the dust collection portion is an acute angle that narrows as approaching the front.

5. The dust collecting attachment according to claim 1, wherein
the bit guiding portion is provided with a cutout extending in an axis line direction of the bit guiding portion and circumferentially separating a part of the bit guiding portion.

6. The dust collecting attachment according to claim 5, wherein
the cutout is provided on an opposite side of the suction port across the axis line of the bit guiding portion in front view.

7. The dust collecting attachment according to claim 5, wherein
the cutout is formed over an angle of 15° or more in the circumferential direction of the bit guiding portion.

8. The dust collecting attachment according to claim 1, wherein
the dust collection portion includes a front tubular portion having the suction port that opens and a rear tubular portion coaxial with the front tubular portion, and
the front tubular portion has a larger diameter than the bit guiding portion.

9. The dust collecting attachment according to claim 8, wherein
the front tubular portion has an inner surface on which a plurality of ribs are formed in a parallel manner, and the suction port is formed by including a plurality of openings divided and formed by each of the ribs.

10. The dust collecting attachment according to claim 8, wherein
the front tubular portion has a length in an axis line direction longer than a length in an axis line direction of the bit guiding portion.

11. The dust collecting attachment according to claim 8, wherein
the rear tubular portion has a diameter larger than a diameter of the front tubular portion and is formed to be shorter than the front tubular portion in an axis line direction.

12. The dust collecting attachment according to claim 1, wherein
the connecting portion is in a plate shape having a thickness smaller than an outer diameter of the bit guiding portion.

13. The dust collecting attachment according to claim 1, wherein
the dust collecting attachment is an integrally molded product made of a rubber having a hardness of 70 to 100.

14. The dust collecting attachment according to claim 13, wherein
the hardness is 85 to 95.

15. A hammering tool formed by mounting the dust collecting attachment according to claim 1 on a bit attached to a front end portion.
